(19) United States
(12) Patent Application Publication
(10) Pub. No.: US 2017/0050851 A1
(43) Pub. Date: Feb. 23, 2017

(54) METHOD FOR MANUFACTURING CARBON QUANTUM DOTS

(71) Applicant: TRANSFERT PLUS, SOCIÉTÉ EN COMMANDITE, Montreal (CA)

(72) Inventors: JÉRÔME CLAVERIE, MONT-SAINT-HILAIRE (CA); JIANMING ZHANG, LONGUEUIL (CA)

(21) Appl. No.: 15/239,880

(22) Filed: Aug. 18, 2016

Related U.S. Application Data
(60) Provisional application No. 62/206,453, filed on Aug. 18, 2015.

(51) Int. Cl. C01B 31/02; C09K 11/65

(52) U.S. Cl. CPC C01B 31/0293; C09K 11/65; C01P 2006/40; Y10S 977/774; B82Y 40/00

(57) ABSTRACT

There is provided a method for manufacturing carbon quantum dots. The method comprises the steps of a) providing a dispersion of self-assembled polymeric nanoparticles in a dispersion liquid. The nanoparticles comprise a copolymer, the copolymer comprising insoluble repeat units that are insoluble in the dispersion liquid and soluble repeat units that are soluble in the dispersion liquid. The nanoparticles have a core/shell structure in which a core is surrounded by a shell, the core being enriched in insoluble repeat units, and the shell being enriched in soluble repeat units. The method further comprises the step of b) carbonizing the core of the nanoparticles in the dispersion, thereby producing the desired carbon quantum dots.

### CROSS REFERENCE TO RELATED APPLICATIONS

This application claims benefit, under 35 U.S.C. §119(e), of U.S. provisional application Ser. No. 62/206,453, filed on Aug. 18, 2015.

### FIELD OF THE INVENTION

The present invention relates to a method for manufacturing carbon quantum dots. More specifically, the present invention is concerned with a method for manufacturing carbon quantum dots via carbonization of self-assembled polymeric nanoparticles.

### BACKGROUND OF THE INVENTION

Quantum dots (QDs) are small nanoparticles having optical and electronic properties different from corresponding macroscopic objects. This phenomenon is prevalent in semiconductors. Indeed, semiconductor quantum dots, such as PbS, CdS and CdSe, have been widely studied as efficient photo-harvesting building blocks for the development of photovoltaic devices and highly active photocatalysts because of their enhanced light-response through size quantization effect. However, potential environmental risks caused by the presence of toxic elements and the imperfect chemical/photo stability of those semiconductor QDs limit their practical applications.

Carbon quantum dots (CQDs) are small carbon nanoparticles, typically less than 10 nm in size, generally with some form of surface passivation. As a class of fluorescent carbon nanomaterials, CQDs generally possess numerous attractive properties, including comparable optical properties to semiconductor quantum dots. Recently, photoluminescent CQDs have indeed been intensely scrutinized due to their low cost, low toxicity, high biocompatibility and good photoluminescence (PL).

Various routes have been developed to synthesize CQDs, such as hydrothermal/microwave carbonization of biomass (e.g., glucose), electrochemical oxidation of graphite, plasma treatment and laser ablation of graphite. Although successful, these synthetic routes present intrinsic limitations which preclude the preparation of CQDs on a large scale. For example, CQDs synthesized by the most popular hydrothermal approach usually require a time-consuming and hardly scalable purification process, such as dialysis to remove reaction residues. Physical approaches, e.g. laser ablation, require a complicated experimental set-up and usually generate small quantities of CQDs. Thus, current synthetic procedures can hardly be implemented on a large scale because they involve high dilutions (dialysis) and extreme experimental conditions (high acidity, high pressure or high voltage). Finally, the resulting CQDs can generally only be stored as dilute colloidal solutions, as they cannot readily be re-dispersed once dried.

### SUMMARY OF THE INVENTION

In accordance with the present invention, there is provided:
1. A method for manufacturing carbon quantum dots, the method comprising the steps of:
   a) providing a dispersion of self-assembled polymeric nanoparticles in a dispersion liquid, wherein the nanoparticles comprise a copolymer, the copolymer comprising insoluble repeat units that are insoluble in the dispersion liquid and soluble repeat units that are soluble in the dispersion liquid, and
   wherein the nanoparticles have a core/shell structure in which a core is surrounded by a shell, the core being enriched in insoluble repeat units, and the shell being enriched in soluble repeat units, and
   b) carbonizing the core of the nanoparticles in the dispersion, thereby producing said carbon quantum dots.
2. The method of item 1, wherein the carbonization in step b) is effected by heating the dispersion at a temperature equal to, or higher than, a carbonization temperature of the insoluble repeat units.
3. The method of item 2, wherein in step b), the dispersion is heated at said temperature and then refluxed at said temperature.
4. The method of item 3, wherein the dispersion is heated and then refluxed at a temperature varying from about 130° C. to about 350° C.
5. The method of item 4, wherein the dispersion is heated and then refluxed at about 170° C.
6. The method of any one of items 3 to 5, wherein said reflux lasts about from about 2 minutes to about 24 hours.
7. The method of item 6, wherein said reflux lasts about 40 minutes.
8. The method of any one of items 1 to 7, wherein the copolymer is a block copolymer comprising at least two different blocks of repeat units: a first block that is insoluble in the dispersion liquid and a second block that is soluble in the dispersion liquid.
9. The method of item 8, wherein the first block is enriched in the insoluble repeat units.
10. The method of item 8 or 9, wherein the second block is enriched in the soluble repeat units.
11. The method of any one of items 1 to 10, wherein the copolymer comprises carbohydrate repeat units.
12. The method of item 11, wherein the carbohydrate repeat units comprise a glucosamine pendant group.
13. The method of any one of items 1 to 12, wherein the copolymer comprises n-acryloyl-D-glusoamine repeat units).
14. The method of any one of items 1 to 13, wherein the copolymer comprises acid repeat units and/or base repeat units and/or ethylene oxide repeat units.
15. The method of any one of items 1 to 14, wherein the copolymer comprises acid repeat units.
16. The method of any one of items 1 to 15, wherein the copolymer comprises acrylic acid repeat units, styrene carboxylic acid repeat units, itaconic acid repeat units, or maleic acid repeat units, or a combination thereof
17. The method of any one of items 1 to 16, wherein the copolymer comprises acrylic acid repeat units.
18. The method of any one of items 1 to 17, wherein the copolymer is a poly(carbohydrate)(acid) copolymer.
19. The method of any one of items 1 to 18, wherein the copolymer is poly(n-acryloyl-D-glusoamine)(acrylic acid).
20. The method of any one of items 1 to 17, wherein the copolymer comprises base repeat units.
21. The method of any one of items 1 to 17 and 20, wherein the copolymer comprises 2-(N,N-dimethylamino)ethyl repeat units, methacrylate 2-(N,N-dimethylamino)ethyl acrylate repeat units, 2-N-morpholinoethyl methacrylate repeat units, 2-diisopropylaminoethyl acrylate repeat units, 2-diisopropylaminoethyl methacrylate repeat units, N-(3-aminopropyl)acrylamide repeat units, N-(3-aminopropyl)methacrylamide repeat units, acryloyl-L-Lysine repeat units, methacryloyl-L-Lysine repeat units, N-(t-BOC-aminopropyl)acrylamide repeat units, N-(t-BOC-aminopropyl)methacrylamide repeat units, 2-(N,N-dimethylamino)ethyl methacrylate repeat units, 2-(N,N-dimethylamino)ethyl acrylate repeat units, 2-(tert-butylamino)ethyl acrylate repeat units, or 2-(tert-butylamino)ethyl methacrylate repeat units, or a combination thereof.
22. The method of any one of items 1 to 21, wherein the copolymer comprises polymer chains of uniform length and monomer distribution.
23. The method of any one of items 1 to 22, wherein the copolymer has been synthesized by Reversible Addition-Fragmentation chain Transfer (RAFT) polymerization.
24. The method of item 23, wherein the copolymer has been synthesized using 2-{[(butylsulfanyl)carbonothioyl]sulfanyllpropanoic acid as a RAFT agent.
25. The method of any one of items 1 to 24, wherein a ratio of a number of insoluble repeat units to the number of soluble repeat units varies from about 26/1 to about 1/26.
26. The method of item 25, wherein the ratio varies from about 5/1 to about 1/5.
27. The method of any one of items 1 to 26, wherein the copolymer has a molecular weight varying from about 1,000 g/mol to about 500,000 g/mol.
28. The method of item 27, wherein the molecular weight varies from about 1,500 g/mol to about 15,000 g/mol.
29. The method of any one of items 1 to 28, wherein the copolymer is present in the dispersion at a concentration varying from about 0.03 g/L to about 300 g/L.
30. The method of item 29, wherein the concentration varies from about 1 g/L to about 50 g/L.
31. The method of any one of items 1 to 30, wherein the dispersion and the nanoparticles are free of surfactants.
32. The method of any one of items 1 to 31, wherein step a) comprises the steps of:
   a1) providing a solution of the copolymer in a solvent; and
   a2) adding to the solution a non-solvent for said insoluble repeat units, thereby producing a mixture of the copolymer in the dispersion liquid;
   a3) agitating the mixture obtained in step a2), thereby causing the self-assembly of said nanoparticles and producing said dispersion.
33. The method of item 32, wherein, in step a3), the mixture is agitated by sonication, by mechanical stirring, by ball-milling, by homogenization, and/or by microfluidization.
34. The method of item 32 or 33, wherein, in step a3), the mixture is agitated by sonication.
35. The method of any one of items 32 to 34, wherein the solvent is ethanol, water, toluene, dichloromethane, chloroform, propanol, methanol, acetone or ethyl acetate, or a mixture thereof.
36. The method of any one of items 32 to 35, wherein the solvent is a mixture of water and ethanol.
37. The method of item 36, wherein the mixture of water and ethanol has an ethanol/water volume ratio varying from about 1:10 to about 10:1.
38. The method of item 37, wherein the ethanol/water volume ratio is about 2:1.
39. The method of any one of items 32 to 38, wherein the non-solvent is water, decanol, nonanol, octanol, heptanol, hexanol, ethyl lactate, diethyl acetamide, octane, nonane, heptane, isopare, xylene, durene, dichlorobenzene, or a mixture thereof.
40. The method of any one of items 32 to 39, wherein the non-solvent is heptanol.
41. The method of any one of items 32 to 40, wherein the non-solvent is n-heptanol.
42. The method of any one of items 32 to 41, wherein the mixture obtained in step a2) has a solvent:non-solvent volume ratio varying about 1:1,000 to about 1:1.
43. The method of item 42, wherein the solvent:non-solvent volume ratio varying is about 4:7.
44. The method of any one of items 1 to 43, further comprising the step c) of isolating the carbon quantum dots from the dispersion liquid.
45. The method of item 44, wherein, in step c), the solvent and the non-solvent are evaporated.
46. The method of item 44 or 45, further comprising the step d) of dispersing in a liquid the carbon quantum dots isolated in step c).
47. The method of item 46, wherein, in step d), the carbon quantum dots are agitated in the liquid.
48. The method of item 46 or 47, wherein, in step d), the carbon quantum dots are agitated by sonication, by mechanical stirring, by ball-milling, by homogenization, and/or by microfluidization.
49. The method of any one of items 46 to 48, wherein, in step d), the carbon quantum dots are agitated by sonication.
50. The method of any one of items 46 to 49, wherein the liquid in step d) is water or a polar solvent.
51. The method of any one of items 46 to 50, wherein the liquid in step d) is water or an organic polar solvent.
52. The method of any one of items 46 to 51, wherein the liquid in step d) is water or an organic alcohol.
53. The method of any one of items 46 to 52, wherein the liquid in step d) is water.
54. The method of any one of items 32 to 53, further comprising the step e) of recycling the solvent and/or the non-solvent.

### BRIEF DESCRIPTION OF THE DRAWINGS

In the appended drawings:

FIG. 1 shows A) the synthetic route to CQDs using copolymers in water (left) to form polymeric nanoparticles (middle), which provide CQDs imaged by HR-TEM (middle right) and observed under UV light (far right), and B) a detail view of a polymeric nanoparticle;

FIG. 2 shows the synthetic route to CQDs using P(AGA)(AA) copolymer: (a) synthesis of P(AGA)(AA) copolymer in aqueous solution, (b) formation of polymeric nanoparticles, and (c) formation of CQDs by carbonization and re-dispersing in water;

FIG. 3 shows (a) TEM image of the polymeric nanoparticles formed by P(AGA)(AA)-1 (56 mg) and (b) the linear correlation between CQD size (particle volume) and the polymer concentration;

FIG. 4 shows TEM images (a-c) of CQDs and their corresponding histograms of size distribution (d)—insets show higher magnification TEM image (a) and HR-TEM images (b, c);

FIG. 5 shows FT-IR spectra of (a) P(AGA)(AA) and (b) as-synthesized CQDs;

FIG. 6 shows (a) typical UV-Vis absorption spectrum of CQDs in water—inset shows the optical images of CQDs samples of different particle sizes under white light (upper row) and 365 nm UV light (lower row)—and (b) PL spectra of CQDs at different excitation wavelengths;

FIG. 7 shows PL spectra of CQDs with Dₘₑₐₙ of ˜2.1 nm (a) and 3.6 nm (b) at different λₑₓ;

FIG. 8 shows a graph of PL vs. Absorbance of the CQDs and Quinine Sulfate;

FIG. 9 shows ¹H-NMR spectra of P(AGA)(AA) samples with AGA/AA molar ratio of 1.5/1(a), 1/4.6 (b) and 1/26 (c). The peaks at ˜0.75-0.8 ppm were assigned to the resonance signal of —CH₃ of RAFT agent. The peaks at ˜0.9-2.75 ppm and at ˜3.1-4.0 ppm were assigned to polymeric protons and glucose protons, respectively;

FIG. 10 shows TEM images of CQDs synthesized with the three polymers listed in Table 1—insets show the corresponding optical images of the CQDs solution under 365 nm UV light;

FIG. 11 shows (a) dry CQDs of Example 1 before and after being re-dispersed in water, (b) CQDs synthesized using the method of the invention (left) and a conventional hydrothermal approach (Yang et al., Chem. Commun. 2011, 47, 11615) (right) after re-dispersion in a solvent, (c) a closer view of the bottom of the re-dispersed CQD solutions as shown in (b), and (d) the bottom of the same re-dispersed CQD solutions under 365 nm UV light;

FIG. 12 shows (a) TEM image of the TiO₂/CQD nanohybrid—inset shows the corresponding HR-TEM image —and (b) a graph of the MB concentration (C/C₀) vs. the reaction time; and

FIG. 13 shows the evolution of UV-Vis absorption spectra during the photodegradation of MB using TiO₂/CQDs as catalyst under visible light (λ>420 nm).

### DETAILED DESCRIPTION OF THE INVENTION

In accordance with the present invention, there is provided a method for manufacturing carbon quantum dots. This method comprises the steps of:
a) providing a dispersion of self-assembled polymeric nanoparticles in a dispersion liquid,
   wherein the nanoparticles comprise a copolymer, the copolymer comprising insoluble repeat units that are insoluble in the dispersion liquid and soluble repeat units that are soluble in the dispersion liquid, and wherein the nanoparticles have a core/shell structure in which a core is surrounded by a shell, the core being enriched in insoluble repeat units, and the shell being enriched in soluble repeat units, and
b) carbonizing the core in the nanoparticles in the dispersion, thereby producing said carbon quantum dots.

As noted above, the copolymer comprises both insoluble and soluble repeat units. This allows copolymer molecules in the dispersion liquid to self-assemble into self-assembled polymeric nanoparticles with a core/shell structure. More specifically, the insoluble repeat units will tend to congregate into a core to minimize their exposure to the dispersion liquid while the soluble repeat units, not being so driven, will tend to remain as a shell around the core. This will produce a core enriched in insoluble repeat units (i.e. the concentration of insoluble repeat units in the core will be larger than the concentration of insoluble repeat units in the shell) and a shell enriched in soluble repeat units (i.e. the concentration of soluble repeat units in the shell will be larger than the concentration of soluble repeat units in the core). Typically, each nanoparticle comprises several molecules of the copolymer.

The polymeric nanoparticles may comprise a mixture of two or more different copolymers, However, in preferred embodiments, the polymeric nanoparticles comprise a single copolymer.

In embodiments, the copolymer is a block copolymer, the block copolymer comprising at least two different blocks of repeat units: a first block that is insoluble in the dispersion liquid and a second block that is soluble in the dispersion liquid. Again, this allows the copolymer to self-assemble into self-assembled polymeric nanoparticles as the insoluble blocks of multiple copolymer molecules will tend to congregate into a core and the soluble blocks attached to these insoluble blocks will form a shell around the core. In embodiments, the insoluble (first) block is enriched in, comprises all, or consists of, the insoluble repeat units. In embodiments, the soluble (second) block is enriched in, comprises all, or consists of, the soluble repeat units. The block copolymer may comprise more that the above-mentioned two blocks. However, in preferred embodiments, the copolymer consists of the first (insoluble) and second (soluble) blocks only.

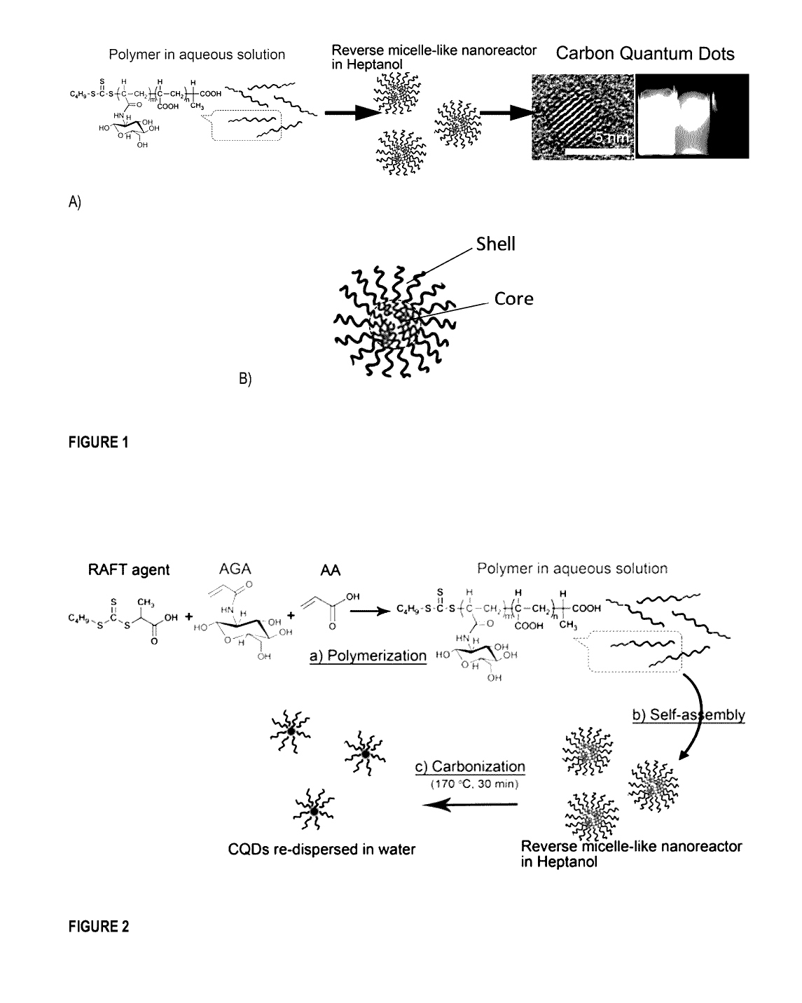

The core/shell structure of the polymeric nanoparticles can be seen in FIG. 1B, in which a dashed circle delineates the core for clarity.

The polymeric nanoparticles self-assemble in a manner similar to micelles. As such, they could be referred to as micelle-like. However, the polymeric nanoparticles are not micelles. Micelles, in particular surfactant micelles, are dynamic. They are characterized by relaxation processes assigned to surfactant exchange and micelle scission/recombination. In contrast, the above polymeric nanoparticles are static and stable once formed. They are not prone to interparticle exchange the way micelles are prone to intermicellar exchange. While the polymeric nanoparticles can, in principle, contain some surfactant, they are not micelles, surfactant micelles, or micelles made of a surfactant; they are nanoparticles made of a copolymer. For clarity, in embodiments of the invention, the dispersion, the nanoparticles, and/or the carbon quantum dots (preferably all of them) are free of surfactants.

In embodiments, the polymeric nanoparticles may further comprise various additives. Non-limiting example of additives include glucose, cellulose, and more generally carbohydrates. In alternative embodiments, the polymeric nanoparticles are free of additives. In fact, in embodiments, the polymeric nanoparticles consist of the copolymer only.

In embodiments, the copolymer comprises carbohydrate repeat units. In preferred embodiments, the carbohydrate repeat units comprise a glucosamine pendant group, which is a good CQD precursor. In more preferred embodiments, the copolymer comprises n-acryloyl-D-glucosamine repeat units.

In embodiments, the copolymer comprises acid repeat units, and/or base repeat units, and/or ethylene oxide repeat units, preferably the copolymer comprises acid repeat units. Acid repeat units are repeat units comprising carboxyls groups (—COOH) Base repeat units are repeat units comprising basic functional groups, such as amine groups [e.g. —NH₂ or —NR₁R₂, wherein R₁ and R2 are independently a hydrogen atom, alkyl (preferably C₁₋₈ alkyl) or aryl (preferably phenyl or benzyl), preferably a hydrogen atom or alkyl] and mercapto groups (—SH). Non-limiting example of acid repeat units include acrylic acid, styrene carboxylic acid, itaconic acid, and maleic acid repeat units as well as combinations thereof. Non-limiting example of base repeat units include 2-(N,N-dimethylamino)ethyl methacrylate 2-(N,N-dimethylamino)ethyl acrylate, 2-N-morpholinoethyl methacrylate, 2-diisopropylaminoethyl acrylate, 2-diisopropylaminoethyl methacrylate, N-(3-aminopropyl)acrylamide, N-(3-aminopropyl)methacrylamide, acryloyl-L-Lysine, methacryloyl-L-Lysine, N-(t-BOC-aminopropyl)acrylamide, N-(t-BOC-aminopropyl)methacrylamide, 2-(N,N-dimethylamino)ethyl methacrylate, 2-(N,N-dimethylamino)ethyl acrylate, 2-(tert-butylamino)ethyl acrylate, and 2-(tert-butylamino)ethyl methacrylate repeat units as well as combinations thereof. In more preferred embodiments, the copolymer comprises acrylic acid repeat units.

In embodiments, the copolymer comprises:
carbohydrate repeat units, and
acid repeat units or base repeat units.
   In preferred embodiments, the copolymer is poly(n-acryloyl-D-glucosamine)(acrylic acid), preferably as a block copolymer.

Depending on the exact nature of the copolymer used, the produced carbon quantum dots will carry various functional groups. For example, the above acid repeat units will confer acidic functional groups and the above base repeat units will confer basic functional groups to the quantum dots.

In embodiments, the copolymer comprises polymer chains of uniform length and monomer distribution. Without being limited by theory, this is believed to favor a more uniform size for the polymeric nanoparticles and ultimately the carbon quantum dots. Such copolymers can be obtained, among other, by synthesizing the copolymer by Reversible Addition-Fragmentation chain Transfer (RAFT) polymerization. RAFT polymerization is one of several known types of controlled radical polymerization. It makes use of a chain transfer agent in the form of a thiocarbonylthio compound (or similar), called a RAFT agent, to afford control over the generated molecular weight and polydispersity during a free-radical polymerization. The RAFT agent, i.e. thiocarbonylthio compounds, such as dithioesters, thiocarbamates, and xanthates, mediate the polymerization via a reversible chain-transfer process. RAFT polymerizations can be performed with conditions to favor low dispersity (molecular weight distribution) and a pre-chosen molecular weight. In embodiments, the RAFT agent is 2-{[(butylsulfanyl)carbonothioyl]sulfanyl}propanoic acid.

In embodiments, the ratio of the number of insoluble repeat units to the number of soluble repeat units in the copolymer is:
about 1/26, about 1/20, about 1/15, about 1/10, and preferably about 1/5 or more; and/or
about 26/1, about 20/1, about 15/1, about 10/1, or preferably 5/1 or less.

In embodiments, the copolymer has a molecular weight (Mn as measured by gel permeation chromatography) of:
about 1,000, about 1,250, or preferably about 1,500 g/mol or more; and/or
about 500,000, about 250,000, about 100,000, about 50,000, or preferably about 15,000 g/mol or less.

In embodiments, the copolymer is present in the dispersion at a concentration of:
about 0.03, about 0.1, about 0.25, about 0.5, about 0.75, or preferably from about 1 g/L or more; and/or
about 300, about 250, about 200, about 150, about 100, or preferably about 50 g/L or less.

In general, increasing the concentration of the copolymer in the dispersion, and/or the above ratio of repeat units, and/or the molecular weight of the copolymer leads to larger nanoparticle sizes, and in turn larger carbon quantum dots. Typically, the carbon quantum dots will have a size of:
about 0.6, about 0.7, about 0.8. about 0.9, about 1.0, about 1.1, or preferably about 1.2 nm or more; and/or
about 8, about 7, about 6, or preferably about 5 nm or less.

Turning now to step a) in more details, in embodiments, this step comprises the steps of:
a1) providing a solution of the copolymer in a solvent; and
a2) adding to the solution a non-solvent for said insoluble repeat units, thereby producing a mixture of the copolymer in the dispersion liquid;
a3) agitating the mixture obtained in step a2), thereby causing self-assembly of said polymeric nanoparticles and producing said dispersion.

In step a1), the copolymer is simply dissolved in a solvent. Then, a non-solvent for the insoluble repeat units is added (step a2)). The mixture of solvent and non-solvent forms the dispersion liquid referred to above. The addition of the non-solvent creates conditions favorable to the formation of the nanoparticles. Some agitation (step a3)) allows formation of the nanoparticles, which will be dispersed in the dispersion liquid.

In embodiments, the solvent is ethanol, water, toluene, dichloromethane, chloroform, propanol, methanol, acetone or ethyl acetate, or a mixture thereof. In preferred embodiments, the solvent is a mixture of water and ethanol. In more preferred embodiments, the mixture of water and ethanol has an ethanol/water volume ratio of:
about 1:10, about 1:8, about 1:6, about 1:4, about 1:2, or about 1:1 or more; and/or
about 10:1, about 8:1, about 6:1, about 4:1, about 3:1, or about 2:1 or less.
   Preferably, the ethanol/water volume ratio is about 2:1.

The non-solvent is miscible with the solvent and, as mentioned above, when mixed with the solvent, it forms the dispersion liquid. In embodiments, the non-solvent is water, decanol, nonanol, octanol, heptanol, hexanol, ethyl lactate, diethyl acetamide, octane, nonane, heptane, isopare, xylene, durene, dichlorobenzene, or a mixture thereof. In preferred embodiments, the non-solvent is heptanol, preferably n-heptanol.

It should of course be understood that while the above lists of examples for the solvent and non-solvent overlap, in any given embodiment of the invention, the solvent is different from the non-solvent.

In embodiments, the mixture obtained in step a2) has a solvent:non-solvent volume ratio of:
about 1:1,000, about 1:500, about 1:200, about 1:100, about 1:50, about 1:25 or more; and/or
about 1:1, about 1:2, about 1:5, or about 1:10 or less.
   Preferably, the solvent: non-solvent volume ratio is about 4:7.

In embodiments, in step a3), the mixture is agitated by sonication, by mechanical stirring (such as with a stirrer and a blade or with a magnetic stir-bar), by ball-milling, by homogenization (using a rotor stator assembly), and/or by microfluidization, preferably by sonication.

Turning now to step b) in more details, in embodiments, the carbonization of the nanoparticle cores in step b) is effected by heating the dispersion at a temperature equal to, or higher than, a carbonization temperature of the insoluble repeat units. In preferred embodiments, in step b), the dispersion is heated at said temperature and then refluxed at said temperature. Of course, the specific carbonization temperature of the insoluble repeat units will depend on their nature. In embodiments, the dispersion is heated and then refluxed at a temperature ranging of:
about 130, about 140, about 150, or about 160 00 or more; and/or
about 350, about 300, about 250, about 200, about 190, or about 180° C. or less.

Preferably, the dispersion is heated and then refluxed at a temperature of about 170° C. In embodiments, the reflux lasts:
about 2, about 5, about 10, about 15, about 20, about 25, about 30, or about 35 minutes or more; and/or
about 24, about 20, about 18, about 16, about 14, about 12, about 10, about 8, about 6, about 5, about 4, about 3, about 2, or about 1 hour or less.
   Preferably, the reflux lasts about 40 minutes.

In embodiments, the method further comprises the step c) of isolating the carbon quantum dots from the dispersion liquid. In preferred embodiments, in step c), the solvent and the non-solvent are evaporated.

In embodiments, the method further comprises the step d) of dispersing the carbon quantum dots [after they have been isolated in step c)] in a liquid. In preferred embodiments, in step d), the carbon quantum dots are agitated in the liquid. In preferred embodiments, in step d), the carbon quantum dots are agitated by sonication, by mechanical stirring (such as with a stirrer and a blade or with a magnetic stir-bar), by ball-milling, by homogenization (using a rotor stator assembly) and/or by microfluidization. In embodiments, the liquid in step d) is water or a polar solvent, preferably an organic polar solvent (such as an alcohol). In preferred embodiments, the liquid is water.

In embodiments, the method further comprises the step e), which may be carried out at any time after step c), of recycling the solvent and/or the non-solvent.

FIG. 1 shows an embodiment of this method wherein carbon quantum dots (CQDs) are synthesized by carbonizing polymeric self-assembled nanostructures. As shown in this figure, the procedure starts with the copolymer in aqueous solution. Then, an organic solvent (immiscible with water), for example heptanol is added. Polymeric nanoparticles are then formed, for example via sonication. Then, the cores of the nanoparticles are carbonized, for example via heating at ˜170° C. to yield the desired CQDs. The produced CQDs can be simply isolated as water evaporates during carbonization and as heptanol is distilled off for re-use. The CQDs can then be re-dispersed, for example in water or another polar solvent, such as an alcohol, for further use. Such re-dispersion can be effected for example by sonication. The CDQ can be of various sizes and are photoluminescent as shown to the right of FIG. 1.

### Potential Advantages

One or more embodiments of the above method may have one or more for the following advantages:
It is mild.
It is environmentally friendly.
It is easy to implement. The nanoparticles are self-assembled. The carbonization is facile.
It is efficient.
It is amenable to large scale production as it should be easily scaled up for mass production using conventional synthetic facilities.
Carboxylic groups (—COOH) and other functional groups, such as amine and mercapto groups, can easily be introduced onto the surface of produced CQDs, by simply varying the copolymer used. The presence of hydrophilic groups (such as —COOH) is believed to yield higher dispersibility in water. The presence of negatively charged groups (such as —COO⁻) is believed to ease adsorption on positively charged surfaces, such as the surface of TiO₂ nanoparticles.
All of the above means that the method renders possible the mass production of multifunctional CQDs for various applications.
The CQDs produced are of high quality.
Without performing any complicated purification or size separation operation, the method allows producing CQDs narrow size distributions (compared with previous synthetic methods: Li et al., Angew. Chemie Int. Ed. 2010, 49, 4430; He et al., Coll Surface B 2011, 87, 326).
The size and optical properties of the CQDs can be controlled by tuning experimental parameters, such as the concentration, nature (e.g. the ratio of the various monomers) and/or the structure of the copolymer. Therefore, the produced CQDs thus have tunable optical properties (such as emission) as their optical properties depends on their size.
The CQDs produced are easily purified.
The quantum yield of the CQDs produced is comparable to those synthesized by hydrothermal approaches, implying good optical quality.
The CQDs produced are readily re-dispersible in one or more solvents. In embodiments, they show superior re-dispersibility in water.
The CQDs produced can be hybridized with TiO₂ nanoparticles. These hybrids have photocatalytic activity under visible-light.

In fact, the method of the invention allows access to high-quality, easily dispersible carbon quantum dots (CQDs). This is essential to fully exploit the desirable properties of carbon quantum dots.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### Description of Illustrative Embodiments

The present invention is illustrated in further details by the following non-limiting examples.

### EXAMPLE 1

We report below an efficient approach to synthesize high-quality dispersible CQDs using self-assembled polymeric nanoparticles.

More specifically, copolymers based on N-acryloyl-D-glucosamine and acrylic acid prepared by Reversible Addition-Fragmentation chain Transfer (RAFT) polymerization were self-assembled into polymeric nanoparticles (herein also called nanoreactors). After a facile graphitization process (170 00, atmospheric pressure), each resulting CQD was a 1:1 copy of the nanoreactor template. The high-quality CQDs (quantum yield≈22%) with tunable sizes (2-5 nm) were decorated by carboxylic acid moieties and could be spontaneously re-dispersed in water and polar organic solvents.

To demonstrate the versatility of this approach, CQDs hybridized TiO₂ nanoparticles with enhanced photocatalytic activity under visible-light have been prepared.

### Synthesis of the CQDs

Our templating approach is based on the use of self-assembled polymeric nanoparticles which are not prone to interparticle exchange. As shown in FIG. 2, poly(acryloyl glucosamine)(acrylic acid) copolymer p(AGA)(AA)) was first synthesized in aqueous solution using a Reversible Addition-Fragmentation chain Transfer (RAFT) polymerization technique (a).

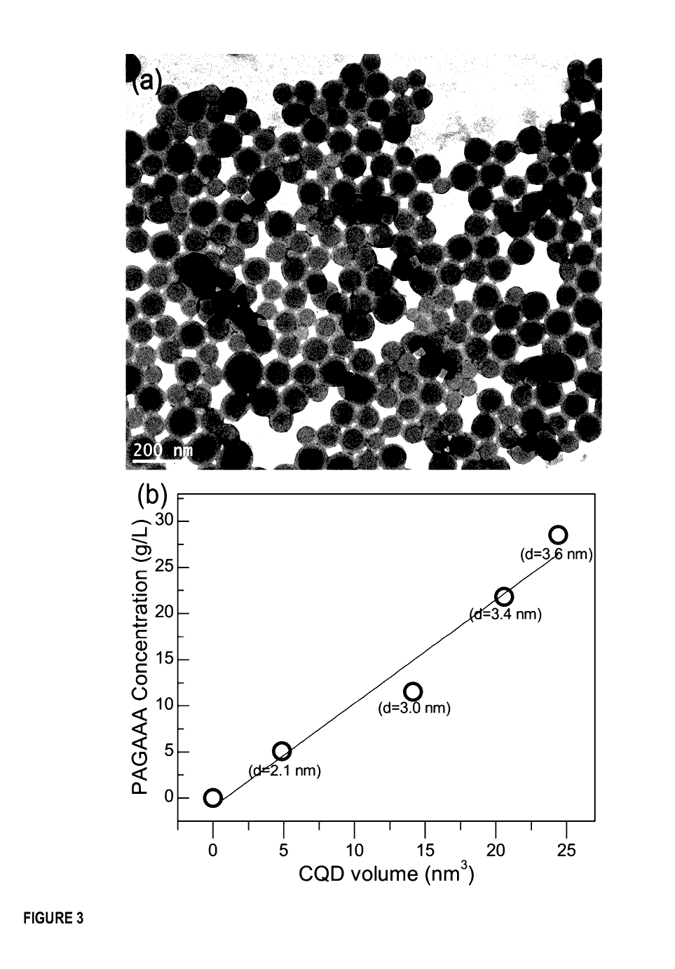

Subsequently, 1-heptanol is introduced to the polymer solution and sonicated to form a light yellow cloudy solution (b). Since PAGA is insoluble in heptanol whereas PAA is soluble, stable polymeric nanoparticles self-assembled upon the addition of 1-heptanol (FIG. 3). The mean size of the polymeric nanoparticles was ˜70 nm. The AGA glucose units were confined in the nanoreactors, whereas the AA units were located at the periphery.

This solution was then heated to ˜170° C. and refluxed for ˜40 minutes under N₂ until a stable brown color was reached. During this thermal treatment, water evaporated, and carbonization was triggered upon intermolecular dehydration of the AGA units to form CQDs (c). Heptanol was then distilled using a simple vacuum distillation in order to be recycled for future uses and the as-prepared dry CQDs can be easily redispersed in water or other polarity solvents (e.g. alcohol) by low power ultrasound (10 minutes sonicator bath, 90 W).

### Results

### Particle Size

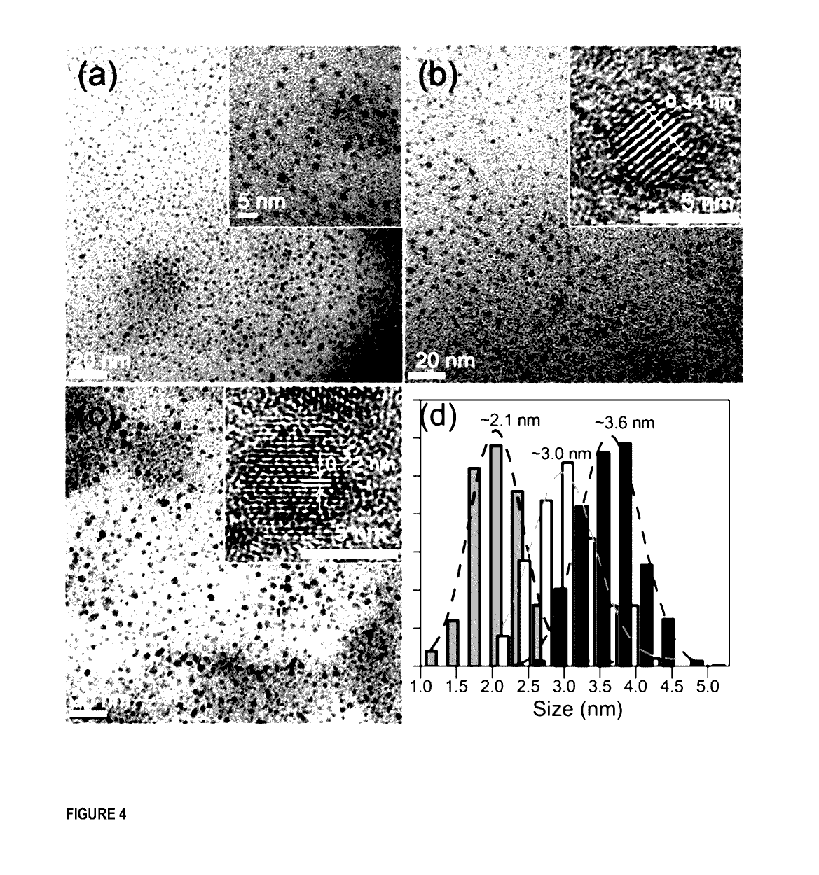

By simply varying the amount of the polymer used for carbonization, CQDs with controllable particle sizes were easily achieved. FIG. 4(a-c) show transmission electron microscope (TEM) images of three CQD samples synthesized using 56 mg, 127 mg to 314 mg of the P(AGA)(AA) polymer (AGA/AA ratio=1.5/1). High-resolution TEM (HR-TEM) images of the CQDs are presented in the inset of FIGS. 4(b) and (c). The lattice spacing is ˜0.34 (b) and 0.22 nm (c), which corresponds to the {002} and {100} facet of graphitic carbon (JCPDS card no. 41-1487), respectively. Statistic measurement of the particle size of the three samples is summarized in FIG. 4(d), where the mean diameter (Dₘₑₐₙ) is shown to be ˜2.1 (a), 3.0 (b) and 3.6 nm (c). The size distribution of the pristine CQDs remained narrow in comparison with previous synthetic methods (Li et al., Angew. Chemie Int. Ed. 2010, 49, 4430; He et al., Coll Surface B 2011, 87, 326).

### FT-IR

FIG. 5 shows the Fourier transform infrared (FT-IR) spectra of the P(AGA)(AA) polymer (upper) and the as-synthesized CQDs (lower). The polymer exhibits a strong characteristic absorption band at ˜3285 cm⁻¹ assigned to the —OH of AGA glucose and AA units. The bands at ˜1704 and ˜1032 cm⁻¹ are assigned to the C═O stretching and the N—H wag, respectively. The absorption at ˜2930 cm⁻¹ indicates the existence of C—H. In contrast, after carbonization, the band of —OH vibrations becomes less prominent in the spectrum of CQDs, and the bands at lower wave numbers corresponding to C═O and N—H are preserved.

The decrease of the intensity of the —OH band is due to the dehydration of the glucose groups of AGA units during the carbonization process. The persistence of the ˜3100-3600 cm⁻¹ of CQDs is mainly attributed to the —COOH groups of AA units, which render the surface of the CQDs hydrophilic and make them self-dispersible in water. Additionally, the AA units acting as ligand molecules on CQDs surface could generate more defect sites on the CQD surface, thus enhancing their optical performance (Sun et al., J. Am. Chem. Soc. 2006, 128, 7756; Kwon and Rhee, Chem. Commun. 2012, 48, 5256).

### Photoluminescence

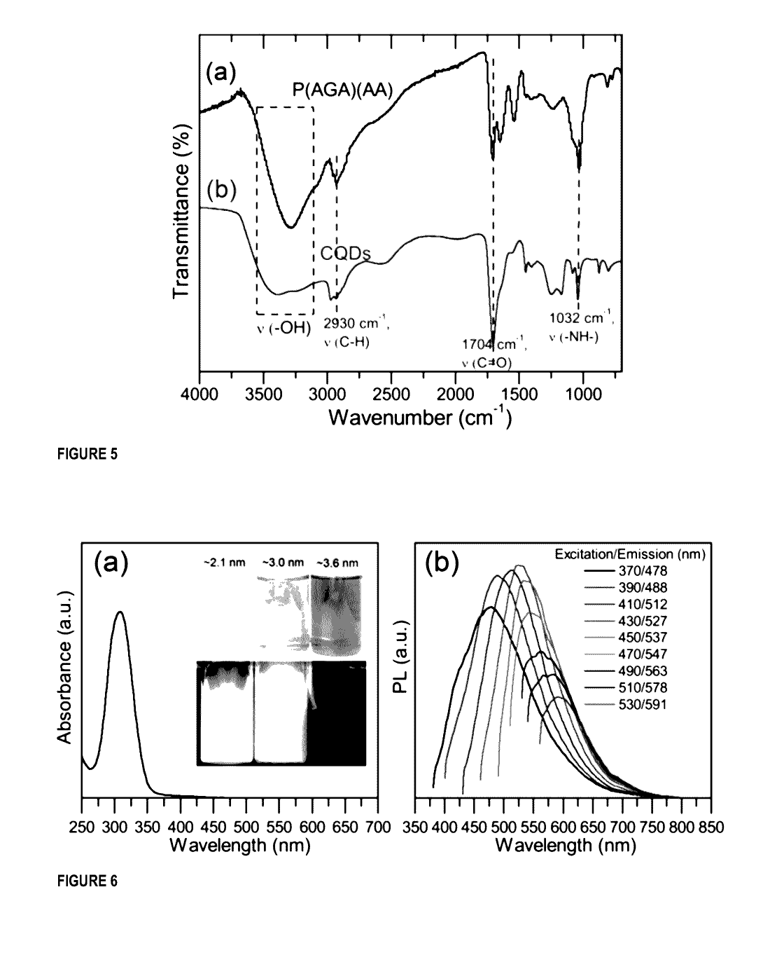

Under white light, the smoky yellow tinge of the CQD solution becomes more pronounced as the particle size increases from ˜2.1 nm to ˜3.6 nm (FIG. 6(a), inset, upper row). Under 365 nm UV-light irradiation (FIG. 6(a), inset, lower row), the solutions appear respectively bright blue, yellow and red color.

The typical UV-Visible (UV-Vis) absorption spectrum of the CQDs (FIG. 6(a)) shows an intense absorption peak at ˜304 nm.

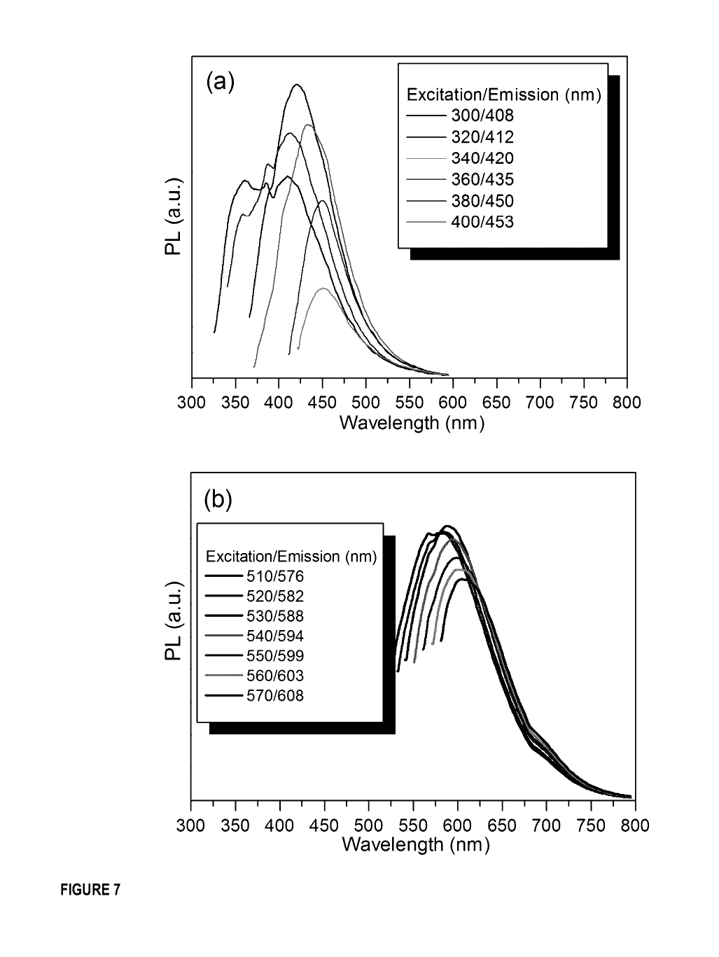

The optical property of the CQDs was further studied using the PL spectroscopy. FIG. 6(b) shows the PL emission spectra of the CQDs (Dₘₑₐₙ=˜3.0 nm) as a function of excitation wavelength (λₑₓ). The PL spectra are collected in the visible region (470-600 nm) and they shift gradually to longer wavelengths when λₑₓ increases from 370 to 530 nm with 20 nm increments. At λₑₓ=430 nm, the maximum PL intensity is achieved with 530 nm emission. These observations indicate a λₑₓ-dependent PL property which is consistent with the observations of previously reported CQDs prepared by other methods (Sun et al., J. Am. Chem. Soc. 2006, 128, 7756; Li et al., J. Mater. Chem. 2012, 22, 24230; Nie et al., Chem. Mater. 2014, 26, 3104; Sahu et al., Chem. Commun. 2012, 48, 8835; Yang et al., Chem. Commun. 2011, 47, 11615; Li et al., Angew. Chemie Int. Ed. 2010, 49, 4430; Yang et al., Chem. Commun. 2012, 48, 380; He et al., Coll Surface B 2011, 87, 326; Kwon and Rhee, Chem. Commun. 2012, 48, 5256; Shen et al., Chem. Commun. 2011, 47, 2580). The PL spectra of CQDs with Dₘₑₐₙ=˜2.1 and ˜3.6 nm show similar λₑₓ-dependent feature (FIGS. 7(a) and (b), respectively). Moreover, the size dependence of PL was confirmed as the red shift in their emission spectra with increase of particle size, which has been widely observed in other semiconductor QDs system due to the quantum confinement effect (Ellingson et al., Nano Lett. 2005, 5, 865; Alivisatos, Science 1996, 271, 933).

### Quantum Yield (QY)

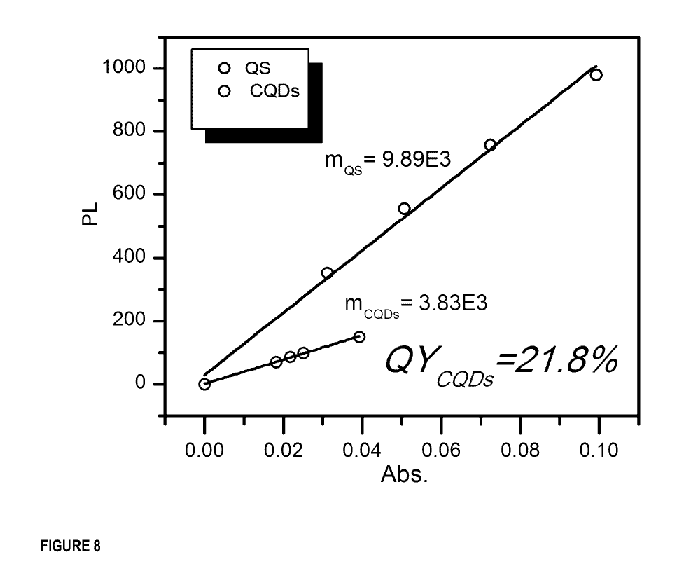

Based on PL measurement, the quantum yield of the CQDs was calculated to be 21.8% (see FIG. 8). This value is comparable to CQDs recently synthesized by hydrothermal approaches (Sahu et al., Chem. Commun. 2012, 48, 8835), implying a good optical quality.

More specifically, according to literature (Kwon and Rhee, Chem. Commun. 2012, 48, 5256), the quantum yield (QY, φ) of CQDs was calculated by using quinine sulfate (QS) as the standard. To calculate the QY, five concentrations of each sample were prepared with absorbance less than 0.1 at 340 nm. QS (literature φ=0.54) was dissolved in 0.1 M of H₂SO₄ (refractive index (η)=1.33), and the CQDs were dispersed in absolute ethanol (η=1.36). Their PL spectra were recorded at λₑₓ=340 nm. Then, PL intensities (λₑₓ=340) and the absorbance (at 340 nm) of the CQD samples and the QS references were compared. The PL-Absorbance data were plotted (FIG. 8) and the slopes of the CQD samples and the QS standards were calculated. The data fitting showed good linearity with intercepts of zero approximately.

The QY of the CQDs was calculated using the following equation:

φ_{C}=φ_{ST}(m_{C}/m_{ST}) (η_{c}²/η_{ST}²)

where φ_{c} is the QY, m is the slope, η is the refractive index of the solvent, ST is the standard and C is the sample. The QY for CQD was thus calculated to be ˜21.8%.

### Tuning Particle Size

The particle size of the CQDs can be tuned simply by varying the polymer structure.

Three polymers with AGA/AA ratio of 1.5/1, 1/4.6 and 1/26 were synthesized. CQDs were subsequently synthesized using 240 mg of the three polymers and characterized by TEM. The results are reported in Table 1.

TABLE 1
Basic parameters of P(AGA)(AA) with different structures
and Dₘₑₐₙ of correspondingly synthesized CQDs.

| Sample | AGA/AA^{a} | Mₙ^{b} | Dₘₑₐₙ (nm)^{c} |
|---|---|---|---|
| P(AGA)(AA)-1 | 1.5/1 | 1657 | 3.4 |
| P(AGA)(AA)-2 | 1/4.6 | 3837 | 2.9 |
| P(AGA)(AA)-3 | 1/26 | 5423 | 2.2 |

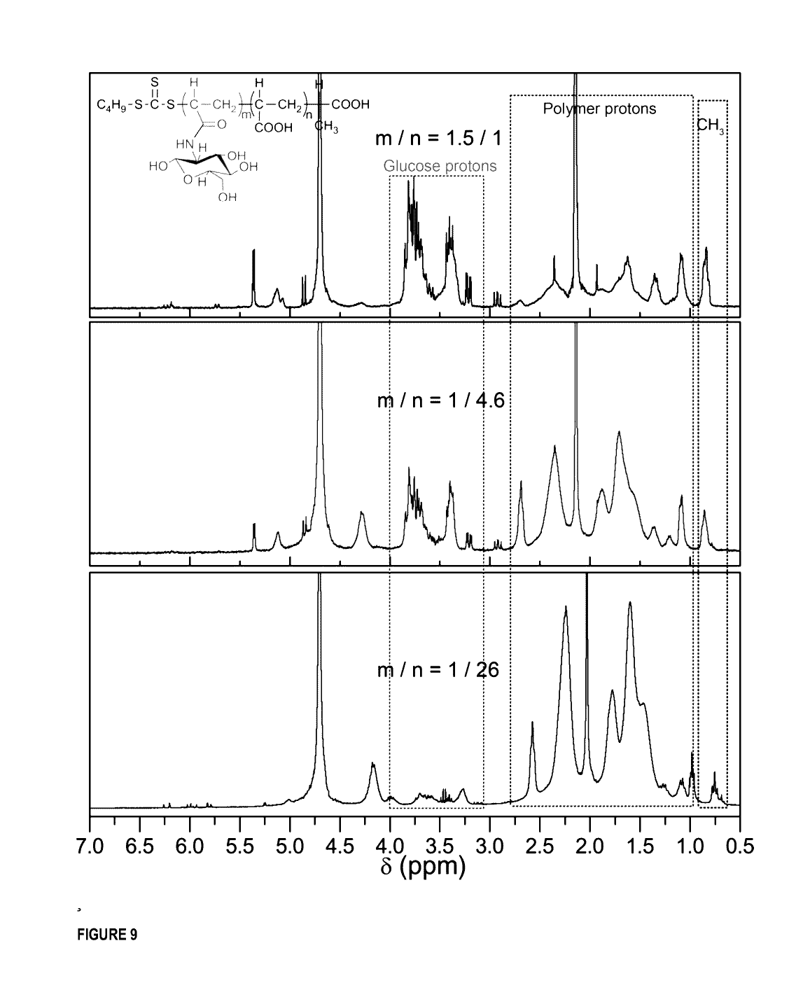

^{a}Determined by ¹H nuclear magnetic resonance (¹H-NMR) spectroscopy (FIG. 9).
^{b}Molecular weight determined by gel permeation chromatography (GPC).
^{c}CQD size determined by TEM.

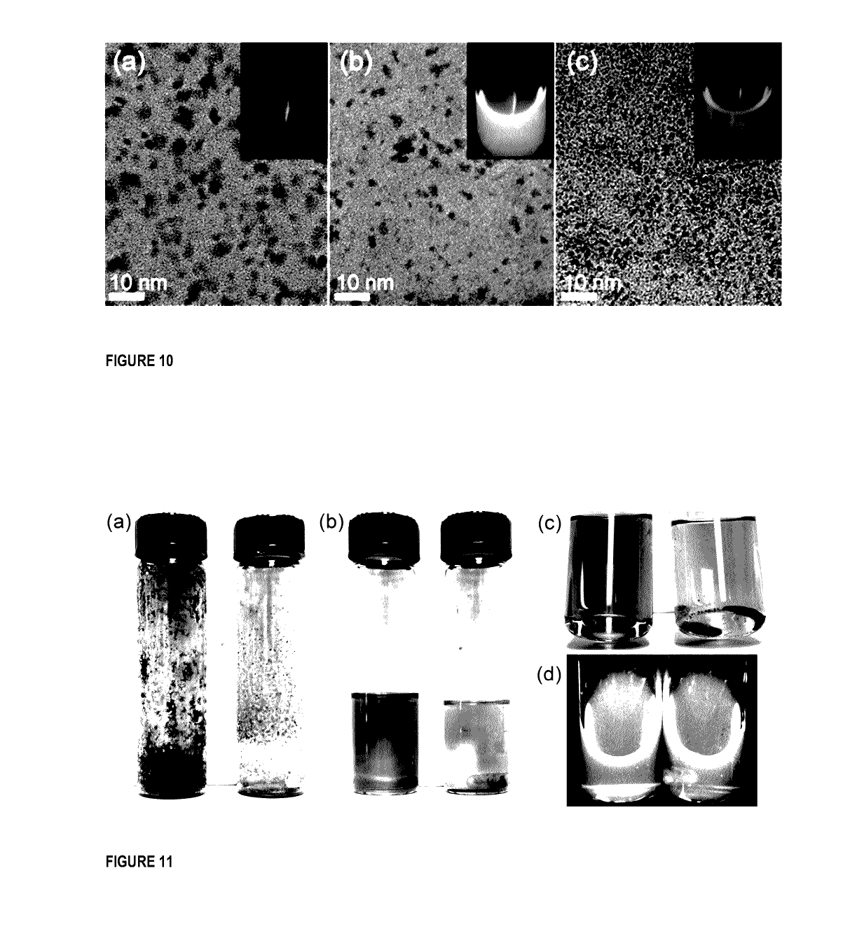

As shown in FIG. 10, the Dₘₑₐₙ of the CQDs was measured to be ˜3.4 (a), 2.9 (b) and 2.2 nm (c) corresponding to polymer sample P(AGA)(AA)-1, -2 and -3, respectively, revealing the size dependence on polymer structure.

The samples showed typical size-dependent luminescence features under 365 nm UV light (insets of FIG. 10).

The origin of this size control is ascribed to the adjustment of the glucose content in the nanoreactor. Increasing the amount of the polymer or the number of AGA units in the polymer chain can lead to a glucose enrichment in the nanoreactor, and thus results in a larger CQD particle size. Once again, the dry CQDs were readily re-dispersed in water under ultrasound.

### Scalability and Re-Dispersability

To demonstrate scalability, 8.74 g of P(AGA)(AA) polymer were transformed in ˜273 mg of dried CQDs which were readily re-dispersed in water.

By contrast, dry CQDs synthesized by a hydrothermal approach were not fully dispersed in water (see FIG. 11). Indeed, it is clear from FIGS. 11(b) and (c) that the polymer approach synthesized CQDs (left) can be highly re-dispersed in water to form a uniform and clear solution without any visible aggregates. However, deposits are observed for the hydrothermal synthesized sample (right), which cannot be re-dispersed although long-time sonication. This comparison proves that the dry CQDs synthesized by polymer approach possess better re-dispersibility.

FIG. 11(d) shows the re-dispersed CQD aqueous solutions under 365 nm UV light. The polymer approach synthesized CQDs (left) showed strong yellow illumination. However, due to the worse re-dispersibility caused by fierce aggregation and deposition of the hydrothermal synthesized CQDs, this solution illumination was significantly less pronounced (right).

Coupling with TiO₂

To testify the performance of the polymeric method synthesized CQDs, the CQDs (Dₘₑₐₙ=˜3.0 nm, herein) were coupled with TiO₂ nanoparticles to form TiO₂/CQD nanohybrid catalyst for the photodegradation of methylene blue (MB) under visible-light (λ>420 nm).

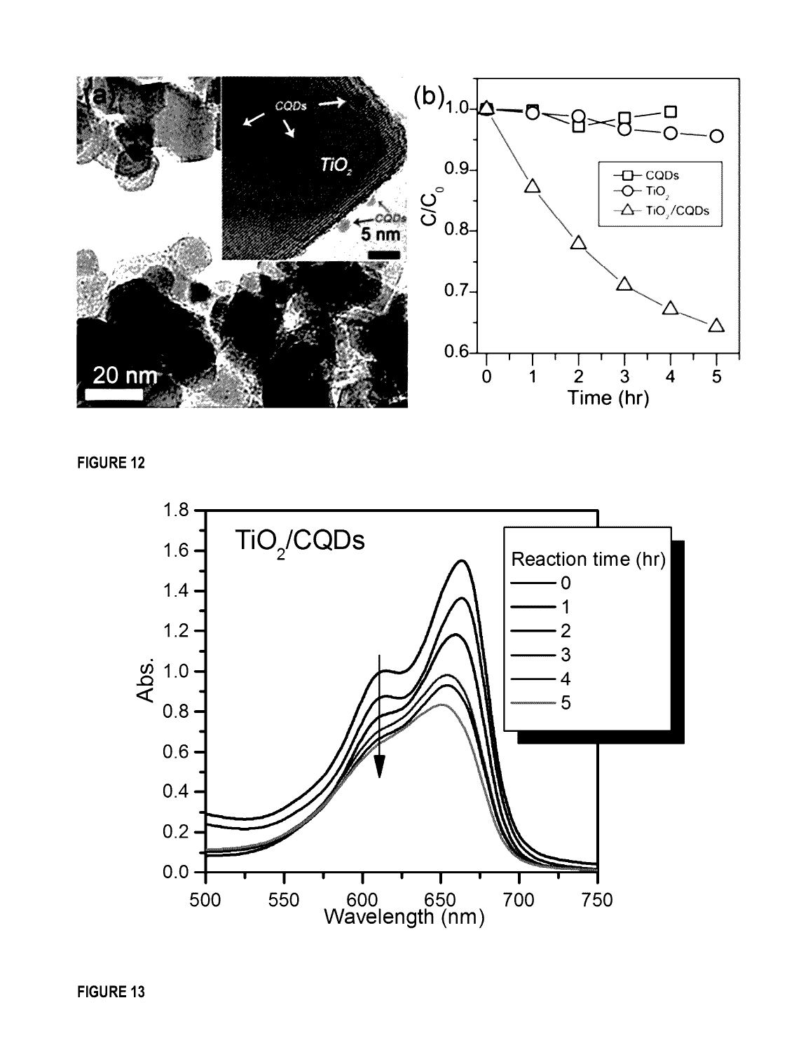

Due to the presence of negatively charged carboxyl groups (—COO⁻) on CQD surface in water (pH=6-7), the CQDs were efficiently adsorbed on the surface of TiO₂, whose surface was slightly positively charged, through an electrostatic interaction. FIG. 12 (a) shows the TEM and HR-TEM image of the TiO₂/CQD hybrid, indicating a good attachment of CQDs on TiO₂ surface.

Through measuring the intensity of the UV-Vis absorption peak of MB solution, the degradation process could be monitored (Zhang et al., Sol. Energy Mater. Sol. Cells 2002, 73, 287)—see FIG. 13. Indeed, the intensity of the UV-Vis absorption peak at 612 nm is directly associated with the concentration of the MB. By measuring this peak as a function of reaction time, the degradation process could be monitored.

FIG. 12(b) plots C/C₀ versus reaction time, where C₀ and C are the concentration of the MB at the beginning and at a certain reaction time, respectively. The MB degradation does not proceed with either CQDs or TiO₂ alone. In contrast, the MB degradation catalyzed by TiO₂/CQD hybrid is highly efficient, as evidenced by the fact that C/C₀ drops rapidly under the same conditions. This comparative study strongly indicates that the cooperation of CQDs and TiO₂ leads to a visible-light active photocatalyst, since neither pure CQDs nor TiO₂ alone contributed to the catalysis. According to previous reports in association with our observation, the remarkably enhanced visible-light photoactivity of the TiO₂/CQD nanohybrids is ascribed that the CQDs mainly acting as semiconductors injecting visible-light excited electrons into the conduction band of TiO₂ (Williams et al., ACS Nano 2013, 7, 1388; Xie et al., J. Mater. Chem. A 2014, 2, 16365), promoting the charge separation of CQDs.

### Detailed Experimental Section

### Materials

D-glucosamine hydrochloride, acryloyl chloride, acrylic acid (AA), 4,4-azobis (4-cyanovaleric acid) (ABV) and TiO₂ nanoparticles were purchased from Sigma-Aldrich. Potassium carbonate (K₂CO₃), sodium nitrite (NaNO₂), methylene blue, hydrochloric acid (HCl), absolute ethanol and 1-heptanol were purchased from Fisher Scientific. RAFT agent of 2-{[(butylsulfanyl)carbonothioyl]sulfanyllpropanoic acid was synthesized as reported by Ferguson et al, in Macromolecules 2005, 38, 2191. The AA was purified using vacuum distillation before using. Other chemicals were used without further purification. Water was Nanopure grade (18.2 MΩ·cm at 25° C.).

### Synthesis of N-aclyloyl-D-glucosamine (AGA) Monomer (Matsuda and Suqawara, Macromolecules 1996, 29, 5375)

Typically, 8.06 g of D-Glucosamine hydrochloride and 0.14 g of NaNO₂ were dissolved in 20 mL of K₂CO₃ aqueous solution (2 M). This solution was purged with nitrogen and cooled to ˜0° C. in an ice bath under vigorously stirring. 4.0 g of Acryloyl chloride was added drop wise over 1 hr. The reaction solution was kept below 5° C. for ˜3 additional hours, while stirring was maintained. After warming to room temperature and stirred for one day, the dispersion was poured into 200 mL of cold absolute ethanol, and refrigerated overnight. After the precipitated salts were filtered off, the resulting solution was dried under vacuum and the product was purified by re-crystallization with methanol (75%) to achieve white powder. The product yield was ˜47%. ¹H-NMR (D₂O, 300 MHz, δ): 6.37-6.08 (m, 2H), 5.74 (dd, J=9.8, 1.8 Hz, 1H), 5.17 (d, J =3.5 Hz, 1H), 4.08-3.26 (m, 8H).

### Synthesis of CQDs

i) Synthesis of P(AGA)(AA): Typically, a mixture of 120 mg of RAFT agent, 100 mg of AGA, 60 mg of AA and 10 mg of ABV (mole ratio of AGA: AA=1:2) were dissolved in 4 mL of degassed ethanol/water (volume ratio 2:1) solution. This solution was heated to 70° C. under stirring with the protection of N2 for 3 hrs to complete the polymerization. The resulting polymer was purified/recovered by precipitation in cold ethanol and dried under vacuum. Yield: 200.5 mg (71.6%). This recipe led to the polymer with AGA/AA ratio of 1.5/1.

ii) Synthesis of CQDs: Typically, 56 mg of the P(AGA)(M) was dissolved in 4 mL of the degassed ethanol/water (volume ratio 2:1). Subsequently 7 mL of heptanol was injected to the polymer solution and sonicated to form a homogenous light yellow cloudy solution. This solution was then heated to 170° C. quickly and refluxed for 40 min with vigorous stirring under N₂ flow until a stable light brown color was achieved. Afterwards, heptanol was removed/recycled by evaporation-condensation under vacuum. The brown residue was cooled down to room temperature and re-dispersed in water by sonication. The turbid light brown aqueous solution was then centrifuged at 3500 rpm for 10 min and the flocculate deposit was discarded. The clear yellow supernatant was collected and filtered using a cellulose syringe filter with pore size of 0.22 μm. The received filtration containing CQDs was then used for characterization and catalytic application.

The amount of RAFT agent and monomers (AGA-FAA) can be magnified to scale up the polymer quantity for the CQDs synthesis. On the other side, under the same reaction and purification conditions, the feeding monomer mole ratio of AGA and AA for polymerization can be adjusted to be 1:17 and 1:30 to achieve the polymers with AGA/AA ratio of 1/4.6 and 1/26, respectively. The polymers with different structures were used for CQDs synthesis as mentioned above.

### Synthesis of TiO₂/CQDs Nanohybrids

To 20 mL of CQD aqueous solution 30 mg of P-25 commercial TiO₂ powder was added. The resulting dispersion was sonicated in sonicator bath for 5 minutes and then heated at 60-70° C. under stirring until the water evaporated completely. The resulting light-yellow powder was then transferred in conventional oven and heated at 300° C. in air for 30 min and cooled to room temperature automatically.

### Photocatalyzed MB Degradation Under Visible-Light

30 mg of catalyst samples (TiO₂ and TiO₂/CQDs) were dispersed in 15 mL of 80 mg/L MB aqueous solution under vigorous stirring in darkness for 6 h to reach an equilibrium adsorption for MB. The solution was centrifuged and the catalyst was washed with a small amount of water and re-dispersed in 10 mL of fresh 8 mg/L MB solution. The dispersion was then irradiated at room temperature using a solar light simulator (Sciencetech Inc., SS0.5KW.) with a cutoff filter (λ>420 nm). The average light intensity was ˜70 mW/cm². At regular intervals, aliquots were removed and analyzed by UV-Vis spectroscopy.

### Characterization

i) FT-IR. The polymer and CQDs were analyzed using a Nicolet 6700 FT-IR spectroscopy equipped with an ATR accessory. ii) TEM. The CQDs was imaged using JEOS-2100F TEM (École Polytechnique de Montréal, Montréal, Canada). iv) ¹H-NMR. Proton nuclear magnetic resonance spectra of the monomer and copolymer were recorded with a Bruker 300 (300 MHz) instrument using Deuterium oxide (D2O) as solvent. v) UV-Vis spectroscopy. UV-Vis absorption spectra were collected using a Varian Cary 100Bio spectrometer. All measurements were done at room temperature. vi) PL. PL property and lifetime of the samples were measured using a Varian Cary Eclipse fluorescence spectrophotometer. vii) GPC. Molecular weight of the polymers was determined using a GPC with water as the mobile phase and equipped with a Wyatt Dawn 18 angle light scattering detector and a Dawn DSP refractometer. viii) DLS. Malvern Zetasizer Nano S-90 was used to measure the size of polymer solution.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
H. Lee, H. C. Leventis, S.-J. Moon, P. Chen, S. Ito, S. A. Hague, T. Torres, F. Nuesch, T. Geiger, S. M. Zakeeruddin, M. Gratzel, M. K. Nazeeruddin, Adv. Funct. Mater. 2009, 19, 2735.
D. Wang, H. Zhao, N. Wu, M. A. El Khakani, D. Ma, J. Phys. Chem. Lett. 2010, 1, 1030
Kongkanand, K. Tvrdy, K. Takechi, M. Kuno, P. V Kamat, J. Am. Chem. Soc. 2008, 130, 4007.
Robel, V. Subramanian, M. Kuno, P. V Kamat, J. Am. Chem. Soc. 2006, 7, 2385.
J. H. Bang, P. V Kamat, ACS Nano 2009, 3, 1467.
K. S. Leschkies, R. Divakar, J. Basu, E. Enache-Pommer, J. E. Boercker, C. B. Carter, U. R. Kortshagen, D. J. Norris, E. S. Aydil, Nano Lett. 2007, 7, 1793.
Harris, P. V Kamat, ACS Nano 2010, 4, 7321.
H. J. Yun, H. Lee, N. D. Kim, D. M. Lee, S. Yu, J. Yi, ACS Nano 2011, 5, 4084.
R. J. Ellingson, M. C. Beard, J. C. Johnson, P. Yu, O. I. Micic, A. J. Nozik, A. Shabaev, A. L. Efros, Nano Lett. 2005, 5, 865.
P. Alivisatos, Science 1996, 271, 933.
M. Derfus, W. C. W. Chan, S. N. Bhatia, Nano Lett. 2003, 4, 11.
J. Tang, L. Brzozowski, D. A. R. Barkhouse, X. Wang, R. Debnath, R. Wolowiec, E. Palmiano, L. Levina, A. G. Pattantyus-Abraham, D. Jamakosmanovic, E. H. Sargent, ACS Nano 2010, 4, 869.
F. H. Cincotto, F. C. Moraes, S. A. S. Machado, Chem.—A Eur. J. 2014, 20, 4746.
Y.-P. Sun, B. Zhou, Y. Lin, W. Wang, K. A. S. Fernando, P. Pathak, M. J. Meziani, B. A. Harruff, X. Wang, H. Wang, P. G. Luo, H. Yang, M. E. Kose, B. Chen, L. M. Veca, S.-Y. Xie, J. Am. Chem. Soc. 2006, 128, 7756.
H. Li, Z. Kang, Y. Liu, S.-T. Lee, J. Mater. Chem. 2012, 22, 24230.
H. Nie, M. Li, Q. Li, S. Liang, Y. Tan, L. Sheng, W. Shi, S. X.-A. Zhang, Chem. Mater. 2014, 26, 3104.
S. Sahu, B. Behera, T. K. Maiti, S. Mohapatra, Chem. Commun. 2012, 48, 8835.
Z.-C. Yang, M. Wang, A. M. Yong, S. Y. Wong, X.-H. Zhang, H. Tan, A. Y. Chang, X. Li, J. Wang, Chem. Commun. 2011, 47, 11615.
L. Tang, R. Ji, X. Cao, J. Lin, H. Jiang, X. Li, K. S. Teng, C. M. Luk, S. Zeng, J. Hao, S. P. Lau, ACS Nano 2012, 6, 5102.
L. Zhang, D. Peng, R.-P. Liang, J.-D. Qiu, Chem.—A Eur. J. 2015, 21, 1.
H. Li, X. He, Z. Kang, H. Huang, Y. Liu, J. Liu, S. Lian, C. H. A. Tsang, X. Yang, S.-T. Lee, Angew. Chemie Int. Ed. 2010, 49, 4430.
Y. Yang, J. Cui, M. Zheng, C. Hu, S. Tan, Y. Xiao, Q. Yang, Y. Liu, Chem. Commun. 2012, 48, 380.
X. He, H. Li, Y. Liu, H. Huang, Z. Kang, S T. Lee, Coll Surface B 2011, 87, 326.
W. Kwon, S.-W. Rhee, Chem. Commun. 2012, 48, 5256.
U. Natarajan, K. Handique, A. Mehra, J. R. Bellare, K. C. Khilar, Langmuir 1996, 12, 2670.
G. Delaittre, J. Nicolas, C. Lefay, M. Save, B. Charleux, Chem. Commun. (Camb). 2005, 1, 614.
T. Nicolai, O. Colombani, C. Chassenieux, Soft Matter 2010, 6, 3111.
J. Loiseau, N. Doeerr, J. M. Suau, J. B. Egraz, M. F. Llauro, C. Ladaviere, J. Claverie, Macromolecules 2003, 36, 3066.
J. Z. Nguendia, W. Zhong, A. Fleury, G. De Grandpre, A. Soldera, R. G. Sabat, J. P. Claverie, Chem. Asian J. 2014, 9, 1356.
N. Gaillard, A. Guyot, J. Claverie, J. Polym. Sci. Part A Polym. Chem. 2003, 41, 684.
M. Vasei, P. Das, H. Cherfouth, B. Marsan, J. P. Claverie, Front. Chem. 2014, 2, 1.
J. Shen, Y. Zhu, C. Chen, X. Yang, C. Li, Chem. Commun. 2011, 47, 2580.
T. Zhang, T. K. Oyama, S. Horikoshi, H. Hidaka, J. Zhao, N. Serpone, Sol. Energy Mater. Sol. Cells 2002, 73, 287.
K. J. Williams, C. A. Nelson, X. Yan, L. Li, X. Zhu, ACS Nano 2013, 7, 1388.
S. Xie, H. Su, W. Wei, M. Li, Y. Tong, Z. Mao, J. Mater. Chem. A 2014,2, 16365.
J. Ferguson, R. J. Hughes, D. Nguyen, B. T. T. Pham, R. G. Gilbert, A. K. Serelis, C. H. Such, B. S. Hawkett, Macromolecules 2005, 38, 2191.
T. Matsuda, T. Sugawara, Macromolecules 1996, 29, 5375.
Korean patent publication no. 10-2013-0138514, Woo et al.

1. A method for manufacturing carbon quantum dots, the method comprising the steps of:
a) providing a dispersion of self-assembled polymeric nanoparticles in a dispersion liquid, wherein the nanoparticles comprise a copolymer, the copolymer comprising insoluble repeat units that are insoluble in the dispersion liquid and soluble repeat units that are soluble in the dispersion liquid, and
wherein the nanoparticles have a core/shell structure in which a core is surrounded by a shell, the core being enriched in insoluble repeat units, and the shell being enriched in soluble repeat units, and
b) carbonizing the core of the nanoparticles in the dispersion, thereby producing said carbon quantum dots.

2. The method of claim 1, wherein the carbonization in step b) is effected by heating the dispersion at a temperature equal to, or higher than a carbonization temperature of the nanoparticles.

3. The method of claim 1, wherein in step b), the dispersion is heated at said temperature and then refluxed at said temperature.

4. The method of claim 1, wherein the copolymer is a block copolymer comprising at least two different blocks of repeat units: a first block that is insoluble in the dispersion liquid and a second block that is soluble in the dispersion liquid.

5. The method of claim 4, wherein the first block is enriched in the insoluble repeat units.

6. The method of claim 4, wherein the second block is enriched in the soluble repeat units.

7. The method of claim 1, wherein the copolymer comprises carbohydrate repeat units.

8. The method of claim 11, wherein the carbohydrate repeat units comprise a glucosamine pendant group.

9. The method of claim 1, wherein the copolymer comprises acid repeat units and/or base repeat units and/or ethylene oxide repeat units.

10. The method of claim 1, wherein the copolymer comprises acrylic acid repeat units, styrene carboxylic acid repeat units, itaconic acid repeat units, or maleic acid repeat units or a combination thereof

11. The method of claim 1, wherein the copolymer is poly(n-acryloyl-D-glusoamine)(acrylic acid).

12. The method of claim 1, wherein the copolymer comprises polymer chains of uniform length and monomer distribution.

13. The method of claim 1, wherein the dispersion, the nanoparticles, and the carbon quantum dots are free of surfactants.

14. The method of claim 1, wherein step a) comprises the steps of:
a1) providing a solution of the copolymer in a solvent; and
a2) adding to the solution a non-solvent for said insoluble repeat units, thereby producing a mixture of the copolymer in the dispersion liquid;
a3) agitating the mixture obtained in step a2), thereby causing self-assembly of said nanoparticles and producing said dispersion.

15. The method of claim 14, wherein the solvent is a mixture of water and ethanol.

16. The method of claim 14, wherein the non-solvent is heptanol.

17. The method of claim 1, further comprising the step c) of isolating the carbon quantum dots from the dispersion liquid.

18. The method of claim 17, further comprising the step d) of dispersing the carbon quantum dots in a liquid.

19. The method of claim 18, wherein the liquid in step d) is water.

20. The method of claim 17, further comprising the step e) of recycling the solvent and/or the non-solvent.
